(19) United States
(12) Patent Application Publication
(10) Pub. No.: US 2026/0014728 A1
(43) Pub. Date: Jan. 15, 2026

(54) CUTTER STRUCTURE FOR CUTTING POLYLACTIC ACID FIBER FILTER RODS

(71) Applicant: CHINA TOBACCO YUNNAN INDUSTRIAL CO., LTD., Kunming (CN)

(72) Inventors: Baoshan Yue, Kunming (CN); Tao Wang, Kunming (CN); Han Zheng, Kunming (CN); Yanfei Shen, Kunming (CN); Jiao Xie, Kunming (CN); Hao Wang, Kunming (CN); Tingting Yu, Kunming (CN); Jing Zhang, Kunming (CN); Yongfa Gui, Kunming (CN); Haiyan Ding, Kunming (CN); Wei Ding, Kunming (CN)

(21) Appl. No.: 18/286,131

(22) PCT Filed: Feb. 16, 2023
(86) PCT No.: PCT/CN2023/076368

§ 371 Date: Sep. 25, 2025

(30) Foreign Application Priority Data
Sep. 23, 2022 (CN) 202211162216.9
Sep. 23, 2022 (CN) 202222521687.6

(51) Int. Cl. B26D 1/15; A24D 3/02; A24D 3/08; B26D 1/00; B26D 7/12

(52) U.S. Cl. CPC B26D 1/15; A24D 3/0254; B26D 1/0006; B26D 7/12; A24D 3/08; B26D 2001/002

(57) ABSTRACT

The present disclosure provides a cutter structure for cutting polylactic acid fiber filter rods and relates to the technical field of cigarette preparation. The cutter structure includes a cutter shaft and cutters, wherein the cutters include a middle cutter and side cutters, the middle cutter is round, and cutting edges of the side cutters are flush with an edge of the middle cutter; hardness of the middle cutter is higher than that of the side cutters, so that the tow middle cutter can be conveniently used for cutting lized tows that have been crystallized in the polylactic acid fiber filter rods; and the side cutters are detachably arranged on side faces of the middle cutter and used for preventing glyceryl triacetate from adhering to the side faces of the middle cutter. The cutter structure provided by the present disclosure is simple in arrangement, the two kinds of cutters are cooperatively arranged, the situation that blades are damaged when the middle cutter collides with random crystallization points in polylactic acid fiber tows is avoided due to high hardness of the middle cutter, the side cutters on the side faces can protect the middle cutter against glyceryl triacetate adhesion, the side cutters are detachably arranged, so as to be conveniently replaced, and therefore the whole structure has higher efficiency and stability for cutting the polylactic acid fiber filter rods.

### TECHNICAL FIELD

The present disclosure relates to the technical field of cigarette preparation, in particular to a cutter structure for cutting polylactic acid fiber filter rods.

### BACKGROUND ART

Polylactic acid (PLA) is a polymer material synthesized chemically from lactic acid, which is obtained through the fermentation of starch from renewable plant resources. It has good recycling and reproduction and biodegradability and has the following characteristics that 1. renewable plant resources (corn, wheat, beet, rice, potatoes, sweet potatoes and the like) and organic wastes (corncobs or roots, stems, leaves and peel of other crops) are used as raw materials, so as to get rid of dependence on timber and petroleum resources and meet the requirements of sustainable development; 2. the polylactic acid can be completely bio-degraded, and will be naturally decomposed into water and carbon dioxide in natural environments after certain time without leading to environmental pollution, the generated carbon dioxide can be reused through plant photosynthesis, a permanent and closed carbon cycling system is formed, and the polylactic acid is a veritable “green material”; 3. compared with three major synthetic fibers of dacron, chinlon and acrylon, energy consumption is low in production of polylactic acid fibers, and the polylactic acid is the polymer material with relatively low resource and environment loads; and 4. the polylactic acid has good processability, and tows can be produced by a general melt spinning method for thermoplastic resin.

At present, the polylactic acid fibers have been developed for use in fields such as tows for cigarettes, however, the polylactic acid fibers for the tows for cigarettes greatly differ from conventional polylactic acid tows for clothing in performance requirement, for example, the polylactic acid fibers for clothing have to meet the requirements of fiber spinning, knitting and textile printing and dyeing, washing and ironing, have to achieve high degree of crystallinity, degree of orientation and mechanical strength, can withstand the temperature of 80-100° C., have to be insoluble and non-swelling in detergent aqueous solutions and dry cleaning solvents, should achieve certain hygroscopicity, and meanwhile adsorb other gas substances in surroundings as little as possible. However, the tows for cigarettes should meet the following requirements that (1) filter rods made by cigarette making are non-toxic and tasteless and high in safety; (2) the tows are high in stability, and can meet the requirements of filter rod forming equipment and process; (3) the tows have proper rigidity and curling performance, so as to achieve good elasticity and blooming performance, the filter rods can meet the requirements of certain rigidity, inhale resistance and appearance quality after adding a plasticizer or adhesive under the condition of low tow filling quantity, and the filter rods have a high yield; (4) the tows have enough heat resistance, and filter tips do not collapse or deform during cigarette smoking; (5) the tows have high filtering efficiency for harmful components in smoke; and (6) sensory quality of the cigarettes is not affected. Thus, it is necessary to develop a special spinning and after-treatment process technology to meet the requirements of use in cigarettes.

For example, Chinese patent for invention CN102763897A has disclosed a preparation method of polylactic acid fiber filter rods. The method includes the following steps of (1) blooming: blooming polylactic acid fiber tows for cigarettes with linear density of 3.5-5.0 Ktex by a commercially-available filter rod forming unit; (2) adhesive dispensing: spraying degradable adhesive to the opened polylactic acid fiber tows for cigarettes; (3) forming and cutting-off; (4) drying of filter rods; and (5) balancing: putting the dried filter rods in a balancing chamber for balancing for 6 hours or longer, so that the polylactic acid fiber filter rods can be prepared. By means of the preparation method of the polylactic acid fiber filter rods provided by the above disclosure, the problem about industrial production of the polylactic acid fiber filter rods can be solved, the polylactic acid fiber filter rods can be produced by the existing commercially-available filter rod forming unit, smoking taste of prepared filter rod cigarettes is close to that of cigarettes with acetate fiber filter rods, and the use requirements of the cigarettes can be met.

However, it should be noted that heat resistance is good when the degree of crystallinity of polylactic acid is high, while crystallization points are easily formed when the degree of crystallinity is high. When the tows are formed into the filter rods, the crystallization points are randomly distributed at different positions of the tows. When the filter rods are cut after being curled, blades easily crack or break due to high-speed movement of the filter rods and the difference between the crystallization points and the tows during force bearing of cutters, leading to frequent shutdown of a cigarette making and filter tip assembling machine. Cross sections of the filter rods are not smooth, the filter rods deform, and an indicator of roundness is unqualified. In addition, compared with the conventional acetate fiber tow filter rods, the polylactic acid fiber filter rods contain glyceryl triacetate, which may adhere to outer sides of the cutters, further leading to damage to the cutters.

Apparently, these problems existing during cutting are not considered in the above preparation method.

Thus, in order to solve the above problems, it is necessary to design a reasonable and efficient cutter structure for cutting polylactic acid fiber filter rods.

### SUMMARY

The present disclosure aims at providing a cutter structure for cutting polylactic acid fiber filter rods. The cutter structure is simple in arrangement, two kinds of cutters are cooperatively arranged, the situation that blades are damaged when a middle cutter collides with random crystallization points in polylactic acid fiber tows is avoided due to high hardness of the middle cutter, side cutters on side faces can protect the middle cutter against glyceryl triacetate adhesion, the side cutters are detachably arranged, so as to be conveniently replaced, and therefore the whole structure has higher efficiency and stability for cutting the polylactic acid fiber filter rods.

In order to achieve the above objectives, the present disclosure provides the following technical solutions:

A cutter structure for cutting polylactic acid fiber filter rods includes a cutter shaft and cutters arranged on the cutter shaft, wherein the cutters include a middle cutter and side cutters, the middle cutter is round, and cutting edges of the side cutters are flush with an edge of the middle cutter;
hardness of the middle cutter is higher than that of the side cutters, so that the tow middle cutter can be conveniently used for cutting crystallized tows in the polylactic acid fiber filter rods; and
the side cutters are detachably arranged on side faces of the middle cutter and used for preventing glyceryl triacetate from adhering to the side faces of the middle cutter when the polylactic acid fiber filter rods are cut.

As a preference of the present disclosure, the middle cutter is an alloy knife, and the side cutters are steel knives.

As a preference of the present disclosure, sharpening heads are arranged on outer sides of the side cutters, so that the glyceryl triacetate adhering to the side cutters is worn down when the side cutters are sharpened by the sharpening heads.

As a preference of the present disclosure, each of the side cutters includes a plurality of blade units, and each of the blade units extends towards the corresponding edges of the middle cutter from the cutter shaft.

As a preference of the present disclosure, cutter feeding devices used for being connected with ends, close to the cutter shaft, of the blade units are arranged on the cutter shaft, and each of the cutter feeding devices includes a motor, a lead screw and a blade jaw, wherein the motor is arranged on an outer side of the cutter shaft, the lead screw is coaxially connected with a rotary shaft of the motor, and the blade jaw is arranged on the lead screw and used for being connected with the end, close to the cutter shaft, of the corresponding blade unit.

As a preference of the present disclosure, the motors are stepping motors.

As a preference of the present disclosure, limiting rods parallel to the lead screws are further arranged between the motors and the blade jaws.

As a preference of the present disclosure, the limiting rods and the lead screws are located on two sides of the blade units respectively.

As a preference of the present disclosure, the number of the side cutters is two, and the two side cutters are tightly attached to the two side faces of the middle cutter.

As a preference of the present disclosure, a drive motor for driving the cutter shaft to rotate is arranged at an end of the cutter shaft.

The cutter structure for cutting the polylactic acid fiber filter rods provided by the present disclosure has the beneficial effects that the cutter structure is simple in arrangement, the two kinds of cutters are cooperatively arranged, the situation that the blades are damaged when the middle cutter collides with the random crystallization points in the polylactic acid fiber tows is avoided due to high hardness of the middle cutter, the side cutters on the side faces can protect the middle cutter against glyceryl triacetate adhesion, the side cutters are detachably arranged, so as to be conveniently replaced, and therefore the whole structure has higher efficiency and stability for cutting the polylactic acid fiber filter rods.

### BRIEF DESCRIPTION OF THE DRAWINGS

FIG. 1 is a schematic diagram of a stereostructure of an embodiment of a cutter structure for cutting polylactic acid fiber filter rods according to the present disclosure;

FIG. 2 is a schematic diagram of a side view structure of an embodiment of a cutter structure for cutting polylactic acid fiber filter rods according to the present disclosure;

FIG. 3 is a schematic diagram of a side view structure of a side cutter in an embodiment of a cutter structure for cutting polylactic acid fiber filter rods according to the present disclosure; and

FIG. 4 is a schematic structural diagram of a cutter feeding device in an embodiment of a cutter structure for cutting polylactic acid fiber filter rods according to the present disclosure.

In the drawings: 1. Middle cutter, 2. Side cutter, 20. Blade unit, 3. Cutter shaft, 4. Sharpening head, 5. Cutter feeding device, 51. Motor, 52. Lead screw, 53. Blade jaw, 54. Limiting rod, and 00. Polylactic acid fiber tow.

### DETAILED DESCRIPTION OF THE EMBODIMENTS

The followings are specific embodiments of the present disclosure, the technical solutions of the present disclosure are further described, however, the present disclosure is not limited to these embodiments.

Exemplary embodiments of the present disclosure will be described in detail with reference to the drawings. It should be noted that unless otherwise specified, relative arrangement and steps of modules and steps illustrated in these embodiments do not limit the scope of the present disclosure.

Meanwhile, it should be understood that in order to facilitate description, flows in the drawings are not merely performed alone, but a plurality of steps are performed in a cross-over manner.

In the description of the present disclosure, it should be understood that orientation or position relationships indicated by terms “center”, “upper”, “lower”, “left”, “right”, “vertical”, “horizontal”, “inner”, “outer”, and the like are orientation or position relationships shown in the drawings, or orientation or position relationships based on which products of the present disclosure are usually placed, are adopted not to indicate or imply that indicated devices or elements must be in specific orientations or structured and operated in specific orientations but only to conveniently describe the present disclosure and simplify description, and thus should not be understood as a limitation to the present disclosure. In addition, terms “first”, “second”, and the like are merely used for distinguishing description and should not be understood as indication or implication of relative importance.

The following description of at least one exemplary embodiment is actually illustrative merely, and never acts as any limitation to the present disclosure or application or use thereof.

Technologies, methods and systems known to those of ordinary skill in the related art may not be discussed in detail, but are intended to be a part of the specification where appropriate.

### Embodiment 1

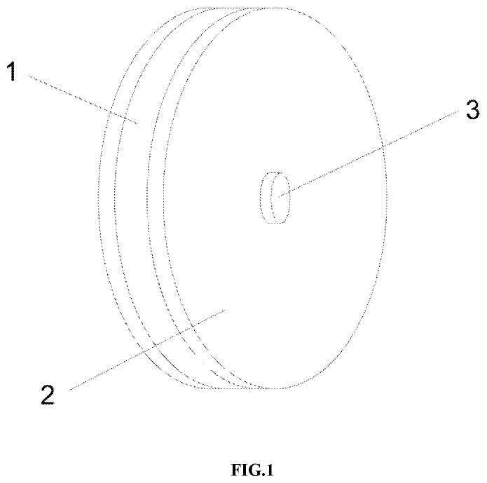

As shown in FIGS. 1-4, a cutter structure for cutting polylactic acid fiber filter rods includes a cutter shaft 3 and cutters arranged on the cutter shaft 3, wherein the cutters include a middle cutter 1 and side cutters 2, the middle cutter 1 is round, and cutting edges of the side cutters 2 are flush with an edge of the middle cutter 1;
hardness of the middle cutter 1 is higher than that of the side cutters 2, so that the tow middle cutter 1 can be conveniently used for cutting tows that have been crystallized in the polylactic acid fiber filter rods; and
the side cutters 2 are detachably arranged on side faces of the middle cutter 1 and used for preventing glyceryl triacetate from adhering to the side faces of the middle cutter 1 when the polylactic acid fiber filter rods are cut.

In the present disclosure, the two kinds of cutters are arranged on the same cutter shaft 3. When rotating, the cutter shaft 3 drives the two kinds of cutters to cut the polylactic acid fiber filter rods at the same time, wherein the middle cutter 1 is round, which is a main body for cutting the polylactic acid fiber filter rods, and therefore the polylactic acid fiber filter rods are cut by edges of outer sides of the middle cutter 1. In addition, the side cutters 2 are arranged on the outer sides of the middle cutter 1, and the cutting edges of the side cutters 2 are flush with the edge of the middle cutter 1, thereby synchronously cutting the polylactic acid fiber filter rods.

Here, the hardness of the middle cutter 1 is higher than that of the side cutters 2, so that the tow middle cutter 1 can be conveniently used for cutting the d tows that have been crystallized in the polylactic acid fiber filter rods. For the middle cutter as the main body for cutting the polylactic acid fiber filter rods, blades are not easily damaged when the middle cutter collides with crystallization points due to high hardness of the middle cutter 1.

In addition, the side cutters 2 are detachably arranged on the side faces of the middle cutter 1 and used for preventing the glyceryl triacetate from adhering to the side faces of the middle cutter 1 when the polylactic acid fiber filter rods are cut. The side cutters 2 shield an outer side of a cutting part of the middle cutter 1, thus, the glyceryl triacetate will merely adhere to sides, away from the middle cutter 1, of the side cutters 2 instead of adhering to the side faces of the middle cutter 1.

It should be noted that the cutting edges of the side cutters 2 are flush with the edge of the middle cutter 1 mainly for the reason that the side cutters 2 need to completely shield portions, making contact with the polylactic acid fiber filter rods, of the side faces of the middle cutter 1, so as to prevent the glyceryl triacetate from adhering to the side faces of the middle cutter 1.

The side cutters 2 may be in various shapes, and may be round or annular, which merely shield portions, close to outer sides, of the middle cutter 1, and the side cutters may be a plurality of long-strip-shaped blades as long as outer ends of the plurality of long-strip-shaped blades can shield the portions, close to the outer sides, of the middle cutter 1.

In the embodiment of the present disclosure, the middle alloy 1 is an alloy knife, and the side cutters 2 are steel knives.

The number of the side cutters 2 is two, the two side cutters are tightly attached to the two side faces of the middle cutter 1, the alloy knife is not easily damaged due to high hardness, and the two steel knives are tightly attached to the outer sides of the alloy knife respectively, so that the glyceryl triacetate will merely adhere to the sides, away from the alloy knife, of the steel knives.

Considering that thicknesses of the steel knives, namely blade units 20, are far less than a thickness of the alloy knife, a cutting effect of the combined cutter for the polylactic acid fiber filter rods still slightly differs from that of the alloy knife alone for the polylactic acid fiber filter rods even when the two steel knives are tightly attached to the two sides of the alloy knife, the cutting edges of the steel knives are tightly attached to the alloy knife, it is proved through an experiment that gaps between the steel knives and the alloy knife are extremely small, and the cutting effect for the polylactic acid fiber filter rods cannot be affected under a tackifying effect of the glyceryl triacetate in the polylactic acid fiber filter rods.

Moreover, as the side cutters 2 are detachably arranged, the outer sides of the steel knives can be sharpened at intervals, or the steel knives can be detached and replaced when abraded, or the steel knives can be replaced during severe adhesion of the glyceryl triacetate to the outer sides of the steel knives. Thus, the combined cutter structure formed by the alloy knife and the steel knives can conveniently cut the polylactic acid fiber filter rods with high degree of crystallinity, and is neither easily damaged, without frequent shutdown, nor be affected by glyceryl triacetate adhesion.

The cutter structure for cutting the polylactic acid fiber filter rods provided by the present disclosure is simple in arrangement, the two kinds of cutters are cooperatively arranged, the situation that the blades are damaged when the middle cutter collides with random crystallization points in polylactic acid fiber tows is avoided due to high hardness of the middle cutter, the side cutters on the side faces can protect the middle cutter against glyceryl triacetate adhesion, the side cutters are detachably arranged, so as to be conveniently replaced, and therefore the whole structure has higher efficiency and stability for cutting the polylactic acid fiber filter rods.

### Embodiment 2

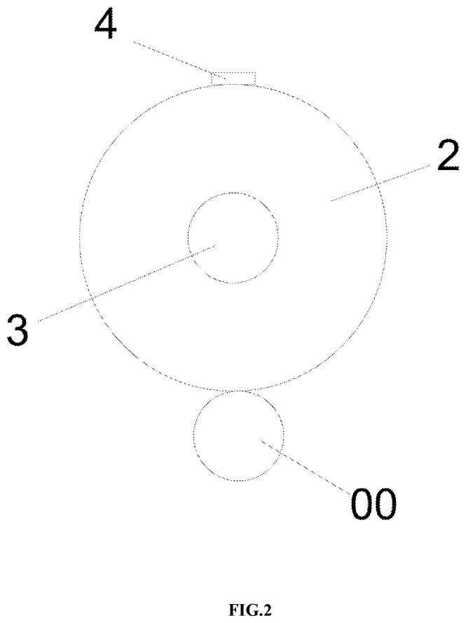

Still as shown in FIGS. 1-4, Embodiment 2 is only one embodiment of the present disclosure, on the basis of Embodiment 1, in the cutter structure for cutting the polylactic acid fiber filter rods provided by the present disclosure, in order to sharpen the side cutters 2, namely the steel knives, sharpening heads 4 are arranged on the outer sides of the side cutters 2, so that the glyceryl triacetate adhering to the side cutters 2 is worn down when the side cutters 2 are sharpened by the sharpening heads 4, of course, the sharpening heads 4 are arranged on a side, away from the polylactic acid fiber tows 00, of the combined cutter structure, as shown in FIG. 2.

It should be noted that the sharpening heads 4 will wear down outer edges of the steel knives, so as to shorten the cutting edges of the steel knives, if the steel knives are round or annular, the steel knives will not extend outwards, the glyceryl triacetate adheres to the alloy knife once the alloy knife is exposed during sharpening under a mild condition, and the alloy knife is abraded when synchronously sharpened under a severe condition. Thus, in order to conveniently sharpen the steel knives, the steel knives are preferably of structures with a plurality of long-strip-shaped blades.

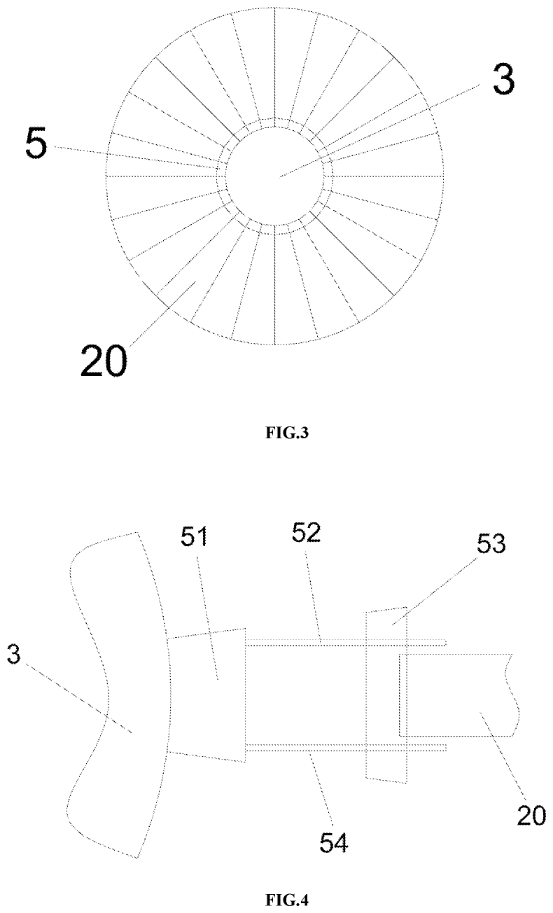

Each of the side cutters 2 includes a plurality of blade units 20, and each of the blade units 20 extends towards the corresponding edge of the middle cutter 1 from the cutter shaft 3. As shown in FIG. 3, each of the blade units 20 is in a long strip shape approximately, however, it is not a strict rectangular structure, the farther the blade units away from the cutter shaft 3, the wider the blade units 20, and even two sides of the blade units 20 can also be properly bent.

Here, cutter feeding devices 5 used for being connected with ends, close to the cutter shaft 3, of the blade units 20 are arranged on the cutter shaft 3, and each of the cutter feeding devices 5 includes a motor 51, a lead screw 52 and a blade jaw 53, wherein the motor is arranged on an outer side of the cutter shaft 3, the lead screw is coaxially connected with a rotary shaft of the motor 51, and the blade jaw is arranged on the lead screw 52 and used for being connected with the end, close to the cutter shaft 3, of the corresponding blade unit 20.

The cutter feeding devices 5 and the blade units 20 rotate along with the cutter shaft 3.

Of course, lead screw holes allowing the lead screws 52 to penetrate through are formed in the blade jaws 53, external threads are arranged on outer sides of the lead screws 52, and internal threads matched with the external threads are arranged on inner sides of the lead screw holes.

That is, inner ends of the blade units 20 are clamped by the blade jaws 53, when the motors 51 drive the lead screws 52 to rotate, the blade jaws 53 and the blade units 20 extend out in a direction away from the cutter shaft 3 based on a lead screw transmission principle, that is, the blade units 20 are made to extend outwards.

Here, the motors 51 are stepping motors, stepping values of the stepping motors can be set according to abrasion of the steel knives, namely sharpening coefficients between the blade units 20 and the sharpening heads 4, so that balance between extension quantities of outward extension of the blade units 20 and abrasion quantities between the blade units 20 and the sharpening heads 4 is ensured.

Various blade units 20 are provided, and all the motors 51 are synchronously controlled in order to make all the blade units 20 extend out jointly, so that all the blade units 20 extend out by the same length at the same time.

Each of the blade units 20 is in the long strip shape approximately, however, it is not a strict rectangular structure, the farther the blade units away from the cutter shaft 3, the wider the blade units 20, and even the two sides of the blade units 20 can also be properly bent, as long as front ends of the plurality of blade units 20 are made to shield positions where the alloy knife makes contact with the polylactic acid fiber filter rods. The blade units 20 are not actual cutting main bodies, the blade units 20 are driven by the cutter shaft 3 to rapidly rotate, and therefore cutting quality of the polylactic acid fiber filter rods cannot be affected by splicing the blade units 20. The glyceryl triacetate adhering to the outer side of the combined cutter is worn down only by utilizing a characteristic that the steel knives can be sharpened by themselves.

Of course, limiting blocks are arranged on the lead screws 52, once the blade jaws 53 abut against the limiting blocks, the blade units 20 extend outwards to the maximum degree, and as a result, staff should be prompted of replacement of new blade units 20. Of course, as a result, the blade jaws 53 can reach positions closest to the cutter shaft 3 by the reverse rotation of the motors 51.

In addition, limiting rods 54 parallel to the lead screws 52 are further arranged between the motors 51 and the blade jaws 53, and the limiting rods 54 are fixedly arranged on motor casings of the motors 51. The limiting rods 54 are smooth, limiting rod holes allowing the limiting rods 54 to penetrate through are formed in the blade jaws 53, and therefore the blade units 20 will not rotate even when the lead screws 52 rotate under limitation of the limiting rods 54. Thus, not only the blade units 20 are stable in structure, but also the blade units 20 can be effectively prevented from extruding the side faces of the middle cutter 1.

Moreover, the limiting rods 54 and the lead screws 52 are located on the two sides of the blade units 20 respectively.

Finally, a driver for driving the cutter shaft 3 to rotate is arranged at an end of the cutter shaft 3.

The cutter structure for cutting the polylactic acid fiber filter rods provided by the present disclosure is simple in arrangement, the two kinds of cutters are cooperatively arranged, the situation that the blades are damaged when the middle cutter collides with random crystallization points in polylactic acid fiber tows is avoided due to high hardness of the middle cutter, the side cutters on the side faces can protect the middle cutter against glyceryl triacetate adhesion, the side cutters are detachably arranged, so as to be conveniently replaced, and therefore the whole structure has higher efficiency and stability for cutting the polylactic acid fiber filter rods.

The present disclosure is not limited to the above specific implementations, and may have various replacements and changes. Any modification, equivalent replacement, improvement, etc. made to the above implementations according to the technical essence of the present disclosure should fall within the scope of protection of the present disclosure.

What is claimed is:

1. A cutter structure for cutting polylactic acid fiber filter rods, comprising a cutter shaft (3) and cutters arranged on the cutter shaft (3), wherein the cutters comprise a middle cutter (1) and side cutters (2), the middle cutter (1) is round, and cutting edges of the side cutters (2) are flush with an edge of the middle cutter (1);
hardness of the middle cutter (1) is higher than that of the side cutters (2), so that the tow middle cutter (1) can be conveniently used for cutting tows that have been crystallized in the polylactic acid fiber filter rod; and
the side cutters (2) are detachably arranged on side faces of the middle cutter (1) and used for preventing glyceryl triacetate from adhering to the side faces of the middle cutter (1) when the polylactic acid fiber filter rods are cut.

2. The cutter structure for cutting the polylactic acid fiber filter rods according to claim 1, wherein the middle cutter (1) is an alloy knife, and the side cutters (2) are steel knives.

3. The cutter structure for cutting the polylactic acid fiber filter rods according to claim 2, wherein sharpening heads (4) are arranged on outer sides of the side cutters (2), so that the glyceryl triacetate adhering to the side cutters (2) is worn down when the side cutters (2) are sharpened by the sharpening heads (4).

4. The cutter structure for cutting the polylactic acid fiber filter rods according to claim 3, wherein each of the side cutters (2) comprises a plurality of blade units (20), and each of the blade units (20) extends towards the corresponding edge of the middle cutter (1) from the cutter shaft (3).

5. The cutter structure for cutting the polylactic acid fiber filter rods according to claim 4, wherein cutter feeding devices (5) used for being connected with ends, close to the cutter shaft (3), of the blade units (20) are arranged on the cutter shaft (3), and each of the cutter feeding devices (5) comprises a motor (51), a lead screw (52) and a blade jaw (53), wherein the motor is arranged on an outer side of the cutter shaft (3), the lead screw is coaxially connected with a rotary shaft of the motor (51), and the blade jaw is arranged on the lead screw (52) and used for being connected with the end, close to the cutter shaft (3), of the corresponding blade unit (20).

6. The cutter structure for cutting the polylactic acid fiber filter rods according to claim 5, wherein the motors (51) are stepping motors.

7. The cutter structure for cutting the polylactic acid fiber filter rods according to claim 5, wherein limiting rods (54) parallel to the lead screws (52) are further arranged between the motors (51) and the blade jaws (53).

8. The cutter structure for cutting the polylactic acid fiber filter rods according to claim 7, wherein the limiting rods (54) and the lead screws (52) are located on two sides of the blade units (20) respectively.

9. The cutter structure for cutting the polylactic acid fiber filter rods according to claim 2, wherein the number of the side cutters (2) is two.

10. The cutter structure for cutting the polylactic acid fiber filter rods according to claim 1, a driver for driving the cutter shaft (3) to rotate is arranged at an end of the cutter shaft (3).
